(19) United States
(12) Patent Application Publication
(10) Pub. No.: US 2023/0337656 A1
(43) Pub. Date: Oct. 26, 2023

(54) Wrap for Game Hunting

(71) Applicant: Brian Wittu, Bloomsdale, MO (US)

(72) Inventor: Brian Wittu, Bloomsdale, MO (US)

(21) Appl. No.: 17/724,973

(22) Filed: Apr. 20, 2022

(51) Int. Cl. A01M 31/00

(52) U.S. Cl. CPC A01M 31/00

(57) ABSTRACT

The cool deer is the only product of its kind that is especially created to guarantee that hunted meat does not decay in warmer temperatures. This unprecedented product is uniquely designed to offer a durable, high-quality, cooling wrap that can be filled either with ice or an electric cooling element to assist in preserving the game. Moreover, the cool deer can be easily transported and packed for convenience; thus, it can easily become a go-to supply for novice as well as skilled hunters, alike.

### BACKGROUND

When enthusiasts are engaged in hunting activities, a common concern is the speed in which the meat must be processed after the game has been hunted as it is critical, especially during hot weather conditions, to ensure the meat does not degrade. Doing so, however, can be difficult for most hunters considering they are often in areas with restricted tools, where there is no electricity and/or they are unable to carry any cooling equipment with them to a formal hunting site. There have been no products available as original equipment or as an aftermarket to address this problem.

An apparatus that is convenient yet effective as preserving game meat from rapidly deteriorating giving hunters added time to be able to get their kill processed is not being met by any known device or system at present. There have been no products available as original equipment or as an aftermarket to address this problem either.

### SUMMARY OF THE INVENTION

The main purpose of the wrap for game hunting is to provide users with a post-kill cooling jacket that prevents deer meat from spoiling.

### BRIEF DESCRIPTION OF THE DRAWINGS

FIG. 1 is a right side perspective view of the wrap for game hunting in accordance with an embodiment of the present disclosure.

FIG. 2 is a front elevational view of the wrap for game hunting in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

The term ‘strap’ is used herein interchangeably with the term ‘belt’ to indicate a flexible band used to hold legs of game together or to encompass the girth of game to handle it and to maintain it and preserve it.

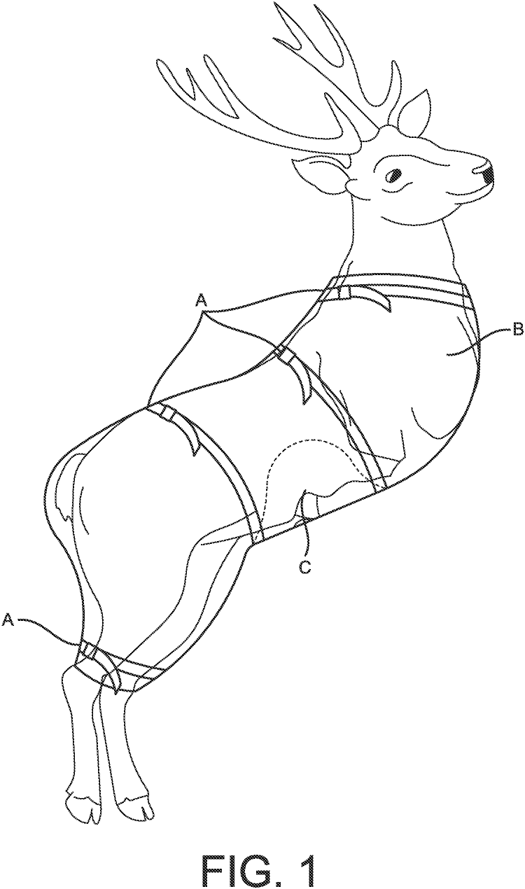

FIG. 1 is a right side perspective view of the wrap for game hunting showing: buckled straps referenced as A, cooling jacket or wrap/filled with ice or cooling element referenced as B, and cooling element inserted in deer cavity referenced as C and the buckle D in accordance with an embodiment of the present disclosure. An outside wrap E is configured outside the buckled straps A. An inside wrap F is configured inside or immediately adjacent the deer.

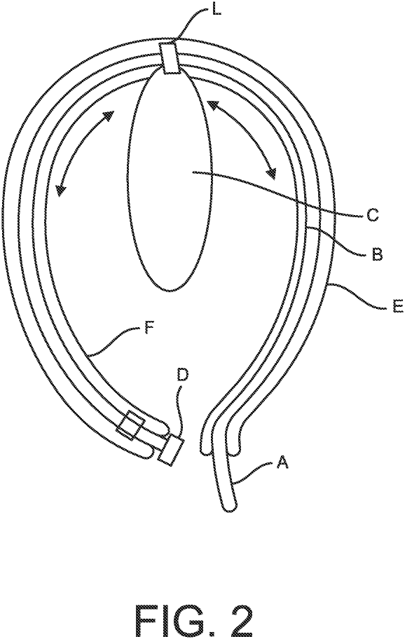

FIG. 2 is a front elevational view of the wrap for game hunting showing: cooling wrap/filled with ice or cooling element referenced as B, and cooling element inserted in deer cavity referenced as C, in accordance with an embodiment of the present disclosure. The view includes the outside jacket or wrap E and the inside jacket or wrap F as described above in the description of FIG. 1. The buckle D includes other fastener types such as a nylon ® ratchet and twist ties. Additionally, a loop L disposes the cooling element C onto a sliding placement on the buckled strap A, also known as a belt or band A.

The present disclosed wrap for game hunting, also known as the “Cool Deer” offers a modern accessory that enables hunters to begin the cooling process of marked game as quickly as possible in order to preserve the meat for future use. The cool deer introduces a novel animal covering jacket specifically designed for deer’s with a strategically placed cooling element. The cool deer can be easily wrapped around the game after harvesting to keep the meat from going bad and ensuring the meat remains at an adequate temperature for long periods of time. This innovative, top-quality product keeps the meat cool for hours and therefore allows hunters to be able to carry-on with their hunting and/or feel confident in their transport to their destination post-hunt, without worrying about their meat getting spoiled in the heat. The cool deer may benefit all individuals who seek to have an easy, convenient, and time efficient means of preserving the meat of their hunted prey.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A jacket for game comprising:
a cooling wrap placed around the game;
a plurality of buckled straps having an adjustable girth adjacent the cooling wrap; and
a cooling element attached to at least one of the plurality of buckled straps, wherein the cooling element is insertable in a deer cavity.

2. The jacket of claim 1, wherein the cooling element comprises a freezable liquid.

3. The jacket of claim 1, wherein the plurality of buckled straps are metal bands.

4. The jacket of claim 1, wherein the cooling element adjusts to dimensions of the deer cavity.

5. The jacket of claim 1, wherein the cooling element is a predetermined shape according to a precluded freezing of the cooling element.

6. The jacket of claim 1, wherein the plurality of buckled straps are nylon ® straps.

7. The jacket of claim 1, wherein the cooling element is ellipsoid.

8. The jacket of claim 1, wherein the plurality of buckled straps position the cooling element in a predetermined position in relation thereto.

9. The jacket of claim 1, further comprising one of the plurality of buckled straps placed around a neck portion of the deer and the cooling element inserted into a neck cavity of the deer.

10. The jacket of claim 1, further comprising one of the plurality of buckled straps placed around a belly portion of the deer and the cooling element inserted into a belly cavity of the deer.

11. The jacket of claim 1, further comprising one of the plurality of buckled straps placed around a chest portion of the deer and the cooling element inserted into a chest cavity of the deer.

12. The jacket of claim 1, further comprising one of the plurality of buckled straps placed around a leg portion of the deer and the cooling element inserted into a thigh cavity of the deer.

13. The jacket of claim 1, wherein the cooling wrap is disposed between the game and the plurality of buckled straps.

14. The jacket of claim 1, wherein the cooling wrap is disposed over the plurality of buckled straps.

15. The jacket of claim 1, wherein a relative placement of the plurality of buckled straps in relation to the deer are predetermined based on a fixed placement on the cooling wrap.

16. The jacket of claim 1, wherein a buckle of the plurality of buckled straps include a ratchet type fastener.

17. The jacket of claim 1, further comprising loops for adjusting a placement of the cooling element relative to a buckle of the plurality of buckled straps.
